(19) United States
(12) Patent Application Publication
(10) Pub. No.: US 2002/0157295 A1
(43) Pub. Date: Oct. 31, 2002

(54) Ornamental image holder

(75) Inventor: Bradley S. Bush, Hilton, NY (US)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 09/796,176

(22) Filed: Feb. 28, 2001

(51) Int. Cl. G09F 3/18

(52) U.S. Cl. 40/661.05

(57) ABSTRACT

The present invention resides in an ornamental holder for holding at least one image. The holder includes a first member having an outer surface and an image retention surface with a window defined between the outer surface and the image retention surface and a second member having a mounting surface, wherein the first member is pivotally connected to the second member to permit pivotal motion of the first member and the second member along parallel planes between a first position wherein the mounting surface confronts the image retention surface to hold the image at the window and a second position wherein the mounting surface is separated from the image retention surface to release the image.

### FIELD OF THE INVENTION

The present invention relates to ornamental image holders such as Christmas ornaments.

### BACKGROUND OF THE INVENTION

With the increasing popularity of conventional and digital photography, there has been increasing interest in ornamental image holders that can be customized to display user selected images and text messages. Such image holders should preferably be cost effective and easily customized while still effectively retaining the images and displaying the images in a visually pleasing manner.

Various customizable Christmas ornaments have been described in the prior art. For example, U.S. Pat. No. 5,713,147 shows an ornamental photograph holder consisting of two transparent half-globular members. Each half globular member is integrally formed with an associated decorative circular frame disc. The discs of each half-globular member are hinged together in a clam-shell fashion. The half-globular members are separated to allow a user to insert a custom image. The ornament is then closed and locked in a closed position by a clasp and tabs.

Another type of customizable Christmas ornament is shown in U.S. Pat. No. 4,224,364. This patent shows a Christmas ornament that is formed from two hemispheres that are preferably transparent. In the '364 patent, the hemispheres are assembled by mating the hemispheres to an annular locking ring. The locking ring defines a snap surface to mate each of the individual hemispheres to the locking ring. To assemble the Christmas ornament, the user mounts a selected image or three-dimensional object to be displayed inside of the locking ring. The hemispheres are then snapped into place on the locking ring to complete the ornament. U.S. Pat. No. 4,173,667 shows a similar customizable Christmas ornament that is sold in a kit form and assembled by the user to contain a custom image or message. The Christmas ornament of the '667 patent also consists of two transparent hemispheres. However, the '667 patent uses a more complex mechanism for assembling the hemispheres.

U.S. Pat. No. 5,458, 930 shows a spherical Christmas ornament having a portal plate on the exterior of the ornament for displaying a user selected image. To install an image in the ornament, the image is cut to the size of the portal plate and attached to the surface of the portal plate using an adhesive. A shield or cover is then fixed over the image to hold and protect the image.

It will be appreciated that the task of customizing the ornaments of the prior art requires substantial user involvement in the assembly of the ornament and in the formatting and installation of the image into the ornament. It will also be appreciated that the ornaments of the prior art are expensive.

What is needed is an image holder that is easily adapted to display images that are selected by the user. What is also needed is an ornamental image holder that effectively retains the image while displaying the image in a pleasing manner. Further, what is needed is an ornamental image holder that is cost effective.

### SUMMARY OF THE INVENTION

The present invention resides in an ornamental holder for holding at least one image. The holder includes a first member having an outer surface and an image retention surface with a window defined between the outer surface and the image retention surface and a second member having a mounting surface, wherein the first member is pivotally connected to the second member to permit pivotal motion of the first member and the second member along parallel planes between a first position wherein the mounting surface confronts the image retention surface to hold the image at the window and a second position wherein the mounting surface is separated from the image retention surface to release the image.

### BRIEF DESCRIPTION OF THE DRAWINGS

FIGS. 1a, 1b, 1c, 1d and 1e show front, top, side, bottom and back views of the ornamental image holder of the present invention.

FIG. 2 shows a perspective view of the ornamental image holder of the present invention in a partially open position.

FIG. 3 shows an embodiment of the first member of the present invention.

FIG. 4 shows an embodiment of the second member.

FIG. 5a shows a cross-section view of an embodiment of the ornamental image holder of the present invention in an open position taken from FIG. 1.

FIG. 5b shows a cross-section view of an embodiment of the ornamental image holder of the present invention in a closed position.

FIG. 6 shows an enlarged view of an embodiment of the locking projection defined on the first member of the present invention.

FIG. 7 shows an enlarged view of an embodiment of the locking recess on the second member of the present invention.

FIG. 8a shows a perspective view of an embodiment of the present invention.

FIG. 8b shows a cross-section view of an embodiment of the present invention.

FIG. 9a shows a perspective view of an alternative embodiment of the present invention wherein the second member is pivotally connected to a pair of first members with the first and second members in the closed position.

FIG. 9b shows a perspective view of an alternative embodiment of the present invention wherein the second member is pivotally connected to a pair of first members with the first and second members in a partially open position.

FIG. 10 shows a cross-section view of the embodiment of FIG. 9a.

### DETAILED DESCRIPTION OF THE INVENTION

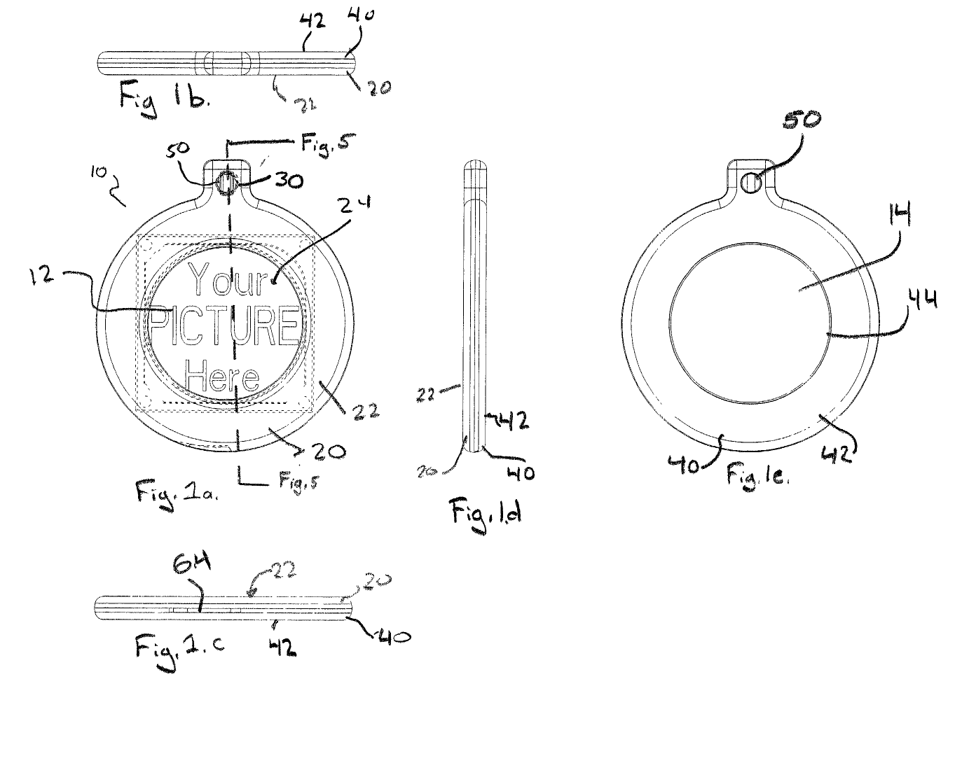

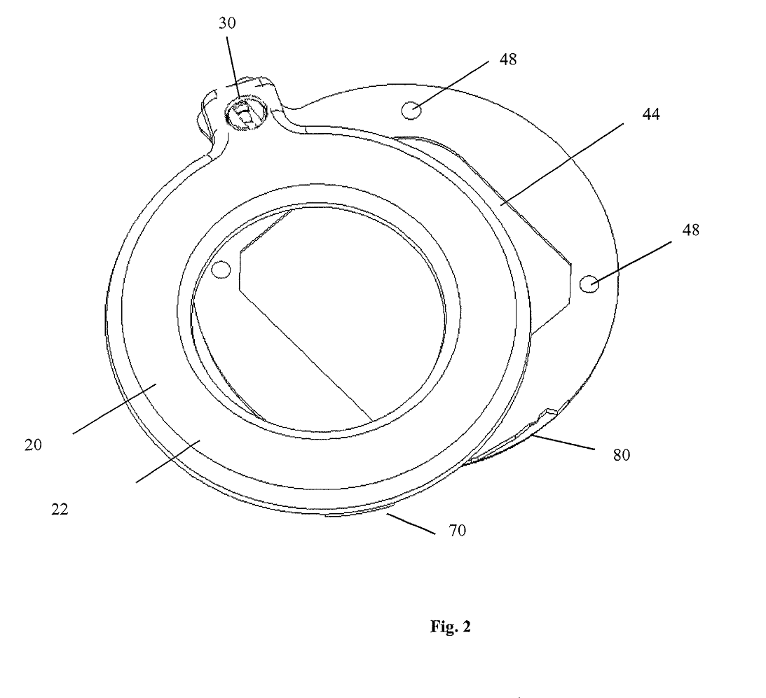

FIGS. 1a-1e show front, top, bottom, side, and back views of the ornamental image holder 10 of the present invention. As is shown FIGS. 1a-1e, the ornamental image holder 10 generally comprises a first member 20 and a second member 40. First member 20 is pivotally joined to the second member 40 to permit the first member 20 and second member 40 to be rotated from a closed position shown in FIGS. 1a-1e to an open position shown in FIG. 2. In the closed position, image 12 is enclosed in the ornament 10 and is visible through a window 24. In the open position, image 12 can be removed from the ornamental image holder 10. As is shown in FIG. 1c, a latch 64 joins first member 20 and second member 40 when the ornamental image holder 10 is in the closed position to prevent the ornamental image holder 10 from inadvertently releasing image 12.

FIGS. 1a and 1e, show the first outer surface 22 and second outer surface 42 of ornamental image holder 10. As is shown in FIG. 1a, first outer surface 22 is formed from first member 20 and is sized and shaped to define a visually pleasing frame for displaying image 12. As is shown in FIG. 1e, second outer surface 42 is formed from second member 20 and is also sized and shaped in a visually pleasing manner. Either of first outer surface 22 or second outer surface 42 can be formed from a material capable of receiving writings or other markings.

As is shown in FIG. 1e, second outer surface 42 optionally features an exterior recess 44 to house a second image 14. Second image 14 can comprise a photograph, graphic image or text message. In the embodiment shown in FIG. 1e, image 14 is installed in exterior recess 44 at the time that the ornamental image holder 10 is manufactured. However, exterior recess 44 can also be used to house a second image 14 that is installed after manufacture.

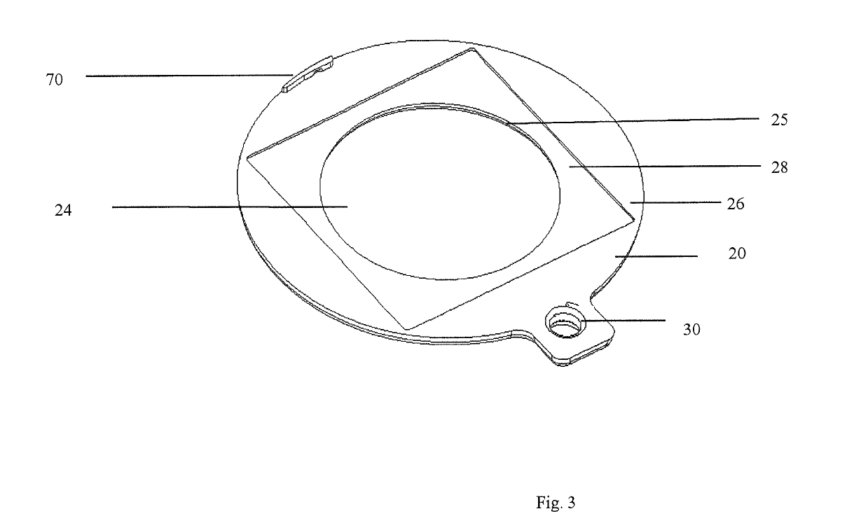

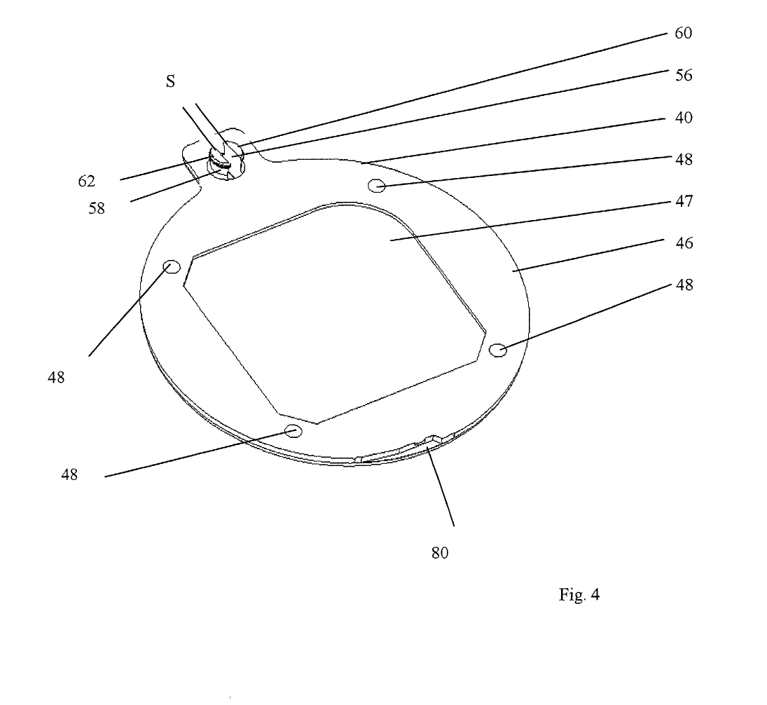

Turning now to FIGS. 3 and 4, various features of first member 20 and second member 40 will be shown and described in greater detail. FIG. 3 shows first member 20 with image retention surface 26 exposed. In the embodiment shown in FIG. 3, window 24 is created by a passageway 25 through first member 20. In other embodiments, window 24 can comprise a transparent glass or plastic surface (not shown) disposed in passageway 25 to permit viewing of image 12 and to protect image 12 from damage. An image retention recess 28 is also shown. Image retention recess 28 is shaped and sized to receive image 12. Image retention recess 28 is aligned with window 24 to present image 12 for display.

FIG. 4 shows image mounting surface 46 of second member 40. Image mounting surface 46 engages image retention recess 28 to retain image 12 in ornamental image holder 10 when image 12 is installed into recess 28 and the ornamental image holder 10 is placed in the closed position.

Optional image contact surfaces 48 are shown in FIG. 4. Image contact surfaces 48 are positioned on image mounting surface 46 and project above image mounting surface 46 and into recess 28 to grip image 12. Also shown in FIG. 4 is an optional mounting recess 47. Mounting recess 47 is located on the image mounting surface 46 and positioned to confront window 24. Optional mounting recess 44 can be used to receive a third image not shown and to position third image for viewing through window 24 in the event that the ornamental image holder 10 is placed in the closed position without image 12 installed in recess 28. In this regard, third image can be used, for example, for promotional purposes or to provide a sample image for viewing by a consumer who is considering the purchase of ornamental image holder 10. Alternatively, a pad or other compressible structure (not shown) can also be placed in mounting recess 44 to support image 12.

First member 20 and second member 40 are joined by pivot 50. In this regard, a pivot passageway 30 is defined on first member 20 between outer surface 22 and image retention surface 26 along an axis that is generally perpendicular to the image retention surface 26. As is shown in FIG. 3, pivot 50 is formed from the substrate of second member 40 and comprises partial cylinder 56 and partial cylinder 58. Partial cylinder 56 and partial cylinder 58 are resiliently joined to image mounting surface 46 and are separated by a predefined space S. Partial cylinder 56 and partial cylinder 58 are sized and arranged to fit pivot passageway 30. Partial cylinder 56 and partial cylinder 58 have shoulder regions 60 and 62 respectively that are oversized with respect to pivot passageway 30.

First member 20 is assembled to second member 40 by pressing the pivot passageway 30 over the pivot passageway 40. This causes pivot passageway 30 to be pressed over pivot shoulder regions 60 and 62. In response to this, partial cylinder 56 and partial cylinder 58 inwardly deform into the predefined space S so that the shoulder regions 60 and 62 can pass through pivot passageway 30.

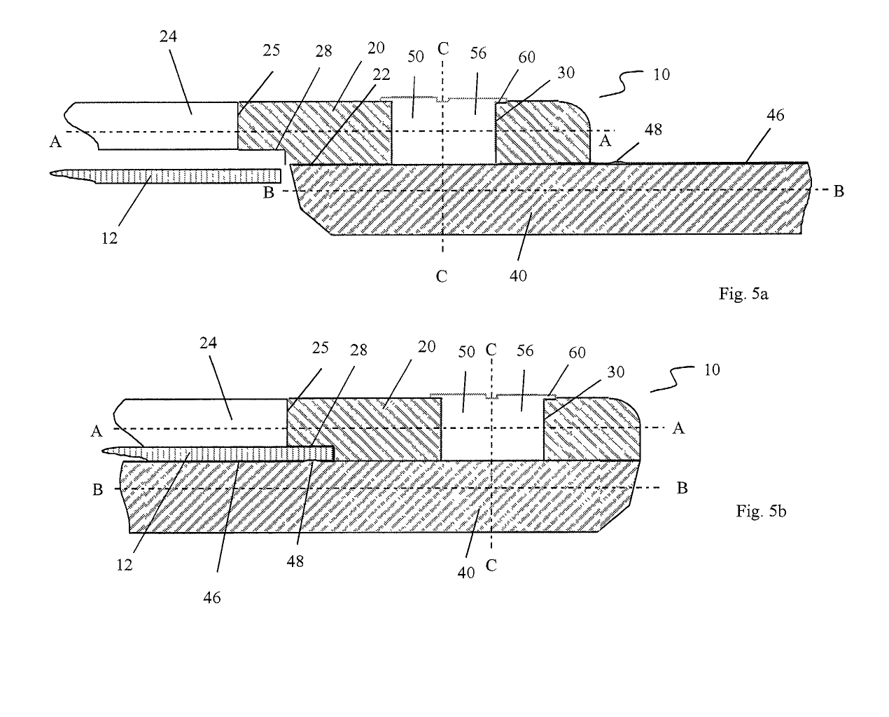

FIGS. 5a and 5b show a partial cross-section view of an assembled ornamental image holder 10 of the present invention in open position 5a and closed position 5b. As can be seen in FIG. 5a, after shoulder regions 60 and 62 have passed through pivot passageway 30, partial cylinders 56 and 58 resiliently expand and project shoulder region 60 and shoulder region 62 over the outer surface 22. This secures first member 20 to second member 40. Partial cylinder 56 and partial cylinder 58 enable first member 20 and second member 40 to pivot about pivot axis C-C along parallel plains A-A and B-B, respectively, between the open position shown in FIG. 5a and the closed position shown in FIG. 5b. In the open position, image 12 can be inserted or removed from image recess 28. An image 12 that is inserted into image recess 28 is fixed in recess 28 by pivoting second member 40 and first member 20 into the closed position shown in FIG. 5b.

In the closed position FIG. 5b, image retention surface 46 provides a covering for image recess 28. This encloses image 12 in image recess 28. As shown in FIG. 5b, image contact surfaces 48 project above image retention surface 46 to apply additional clamping force to hold image 12 within image recess 28.

It will be appreciated that, ornamental image holder 10 of the present invention, can be formed with the pivot 50 formed from the substrate of first member 20 and the pivot passageway 30 defined as a feature of second member 40. Further, it will be appreciated that the present invention can also be practiced using a pivot 50 comprising a fastener (not shown) such as a rivet, screw, nut and bolt combination or clevis bolt and cotter pin combination, or other fastener to combine a first member 20 and second member 40 and to permit pivotal motion of the first member 20 relative to the second member 40. In such an embodiment, a second pivot passageway (not shown) is defined in the second member 40.

Once image 12 is placed into image recess 28 and ornament 10 is in the closed position, it is desirable to prevent the inadvertent or unintended release of image 12. The release of image 12 can occur in two ways. The first way in which image 12 can be released from the ornamental image holder 10 occurs when first member 20 and second member 40 are permitted to freely pivot relative to each other. Latch 64 is used to reduce the possibility that first member 20 and second member 40 will freely pivot in such a way as to make the unintended release of image 12 possible.

The operation of the latch 64 will now be discussed with reference to FIGS. 3, 4, 5a, 5b, 6 and 7. FIGS. 3 and 4 show the components of latch 64. In this regard, FIG. 3 shows a latch projection 70 is defined on the image retention surface 26 of first member 20 at a point that is separated from pivot passageway 30. FIG. 4 shows a latch recess 80 is defined on mounting surface 46 of second member 40. Latch projection 70 and latch recess 80 are shaped and positioned for mutual engagement when the ornamental image holder 10 is in the closed position, shown in FIG. 5b.

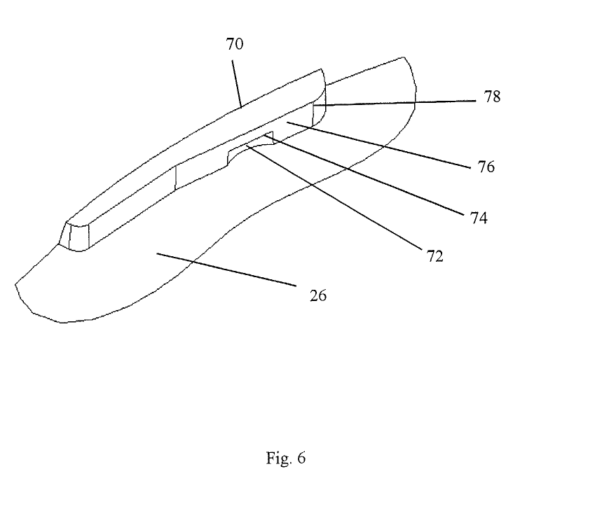

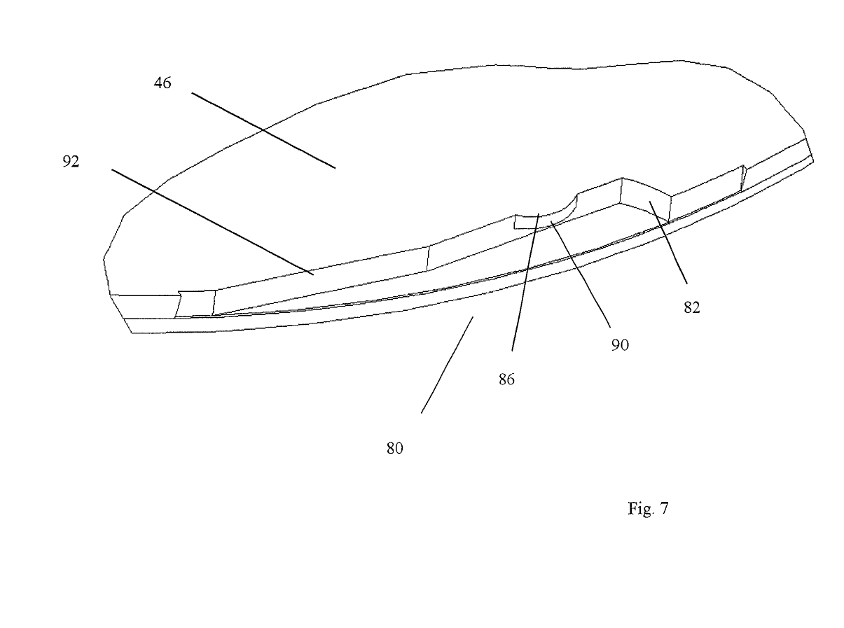

FIG. 6 shows an enlargement of the latch projection 70. As can be seen from FIG. 6, latch projection 70 defines an engagement surface 76, a shoulder 78 and a detent 72. FIG. 7 shows an enlargement of a latch recess 80 of the present invention. Latch recess 80 comprises, generally, a recess 88 having a mounting surface 90 and a mounting ramp 92. An insert 84 projects from mounting surface 90 and is shaped and located for engagement with detent 72.

When first member 20 and second member 40 are moved from the open position shown in FIG. 5a, toward the closed position shown in FIG. 5b, engagement surface 76 is brought into sliding engagement with mounting surface 90. As the ornamental image holder 10 continues to move toward the closed position, insert 84 contacts shoulder 78. Shoulder 78 has an arcuate surface that guides shoulder 78 to slide over indent 84 without damage to indent 84. The accurate surface of shoulder 78 is connected to engagement surface 76. Thus, as first member 20 and second member 40 are further rotated toward the closed position, indent 84 slidably contacts shoulder 78 and is guided to contact engagement surface 72. Ornamental image holder 10 enters the closed position when indent 84 enters detent 72. The engagement of indent 84 with detent 72 resists further pivotal motion of the first member 20 with respect second member 40 and provides a positive indication to the user that ornamental image holder 10 is in the closed position.

In the embodiment of the ornamental image holder shown in FIGS. 3, 4, 5a, 5b, 6, and 7 latch recess 80 also comprises an optional stop 82. Stop 82 is used to engage shoulder 78 to prevent pivotal motion of first member 20 relative to second member 40 at a defined point. Preferably, the point where shoulder 78 engages stop 82 is defined at the closed position. In this manner, first member 20 is prevented from rotating relative to second member 40 beyond the closed position thus preventing the ornamental image holder 10 from releasing image 12 as a result of continued rotation.

The second way in which image 12 can be separated from ornamental image holder 10 is for a gap or space to come into existence between image retention surface 26 of first member 20 and mounting surface 46 of second member 40. This may occur, where for example, forces are applied away from the pivotal connection between first member 20 and second member 40. Such forces can cause a clam-shell type separation of image retention surface 26 and mounting surface 46. If this separation becomes large enough, image 12 can escape from recess 28. Accordingly, it is desirable to secure first member 20 to second member 40 at a position that is separated from pivot 50. In the embodiment shown in FIGS. 3, 4, 5a, 5b, 6 and 7, insert 84 and detent 72 are shown respectively as comprising a groove 74 and tongue 86. The engagement of groove 74 with tongue 86 resists separation of the first member 20 from second member 40 at the point at which the groove 86 and tongue 74 engage each other. Groove 86 and tongue 74 are arranged along an axis that is normal to the direction of separation of first member 20 and second member 40. This resists the creation of a clam-shell opening in ornament 10.

It will be appreciated that detent 72 and insert 84 take on many shapes to accomplish this purpose. For example, insert 84 can comprise a ball (not shown) while detent 72 can take the form of a cup (not shown) receive the ball. The ball/cap arrangement would then resist rotational separation as well as clam-shell separation.

The degree to which the inadvertent release of the separation of the first member 20 from the second member 40 either by pivotal rotation or clam-shell separation, will be understood to be a function of the amount of force required to cause the insert 84 to separate from the detent 72. One way to increase the amount of force required to separate these components is to apply a bias tending to draw insert 84 into close contact with the detent 72.

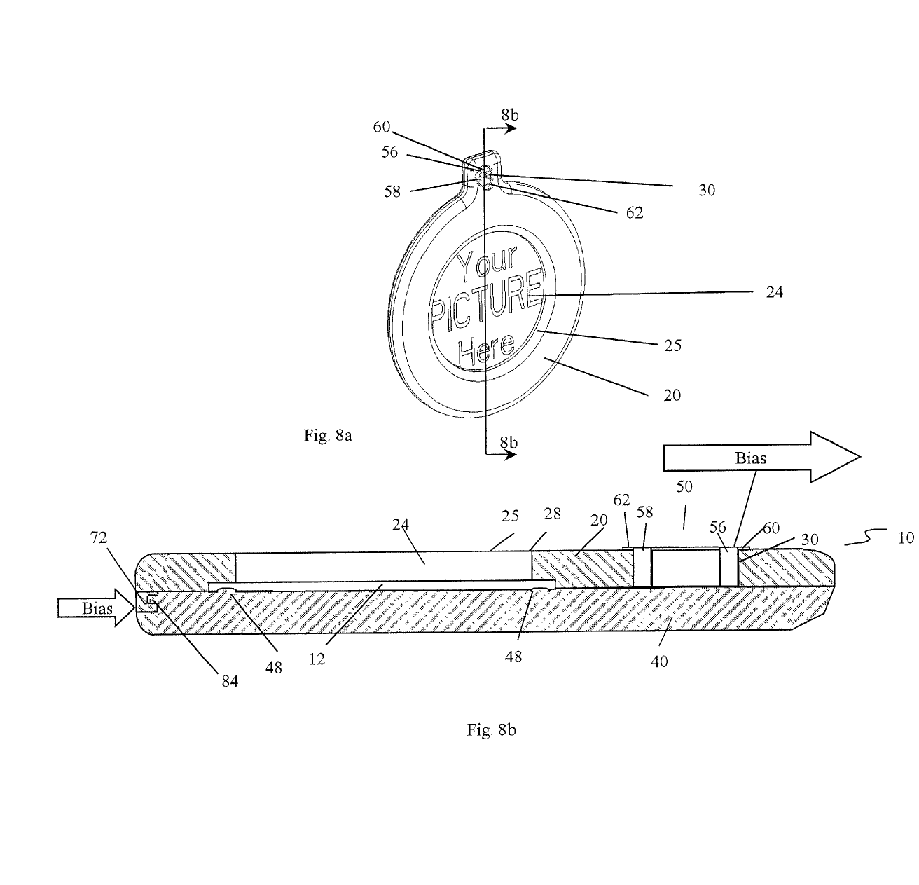

As is shown in FIGS. 8a and 8b, in a preferred embodiment of the present invention a bias force can be provided by a pivot 50 which exerts a bias tending to draw detent 72 into engagement with insert 84. In the embodiment of FIG. 8, this is accomplished by defining partial cylinder 56 and partial cylinder 58 so that partial cylinder 56 continues to apply a bias after assembly. This bias is directed along an axis that tends to draw detent 72 and insert 84 into tighter engagement. In the embodiment shown in FIGS. 8a and 8b, pivot 50 is positioned at one end of ornamental image holder 10 while detent 72 and insert 84 are positioned at an opposite ends of the ornamental image holder 10. In this embodiment, partial cylinders 56 and 58 are arranged so that partial cylinder 56 continues to exert a bias against passageway 30. This bias is directed along an axis extending from the center line of the force applied by partial cylinder 56 to detent 72 and insert 84. A portion of this bias may be offset by engagement between partial cylinder 58 and pivot passageway 30, however, the offset bias provided by partial cylinder 58 is defined to be less forceful than the bias provided by cylinder 56. Thus, there is a net bias in a direction that tends to draw detent 72 into engagement with insert 84. This increases the ability of ornamental image holder 10 to retain image 12.

It will be appreciated that in an alternative embodiment, latch 64 can be defined with projection 70 fixed to second member 40 and with recess 80 formed from first member 20.

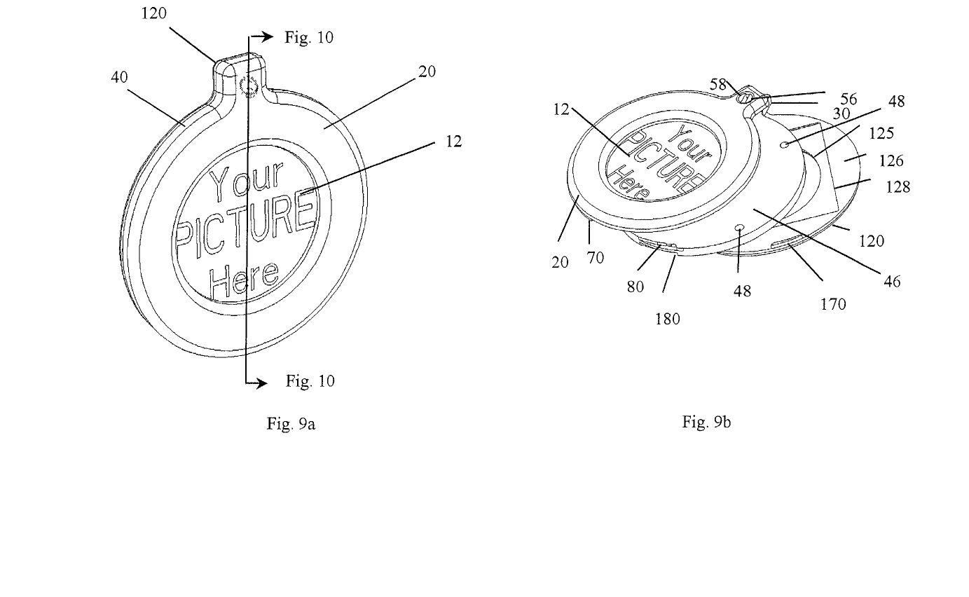

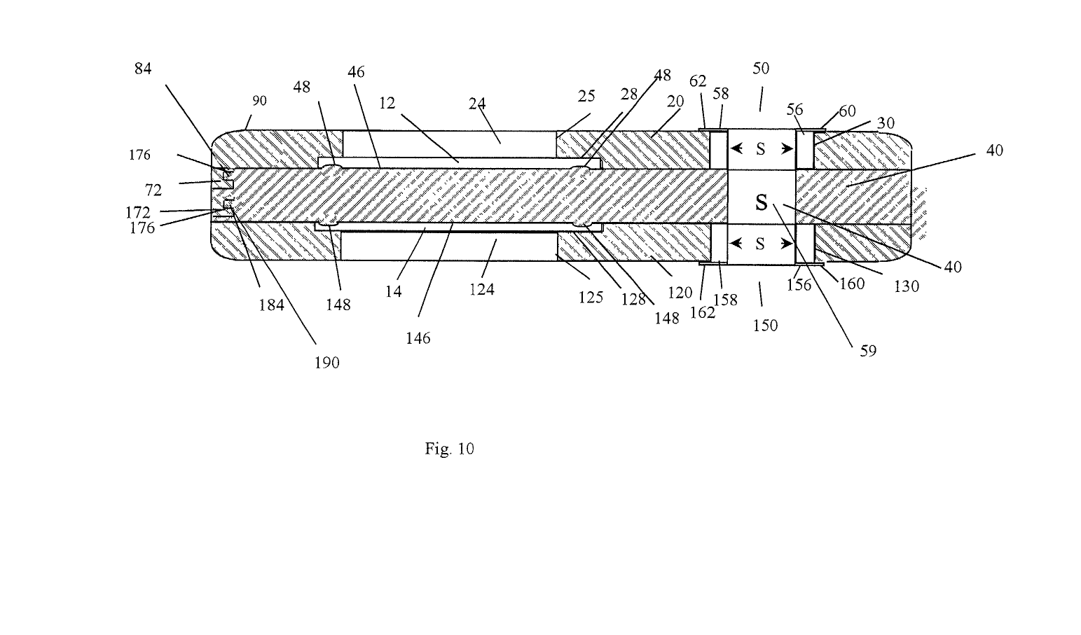

FIGS. 9a, 9b and 10 show an alternative embodiment of ornamental image holder 10 of the present invention. As is shown in FIGS. 9a, 9b and 10, ornamental image holder 10 comprises a first member 20 as described above and a third member 120. Third member 120 comprises the same features that are described above in association with first member 20, including an outer surface 122, a window 124 with a passageway 125 defined therethrough, an image retention recess 128 and a pivot passageway 130. Third member 120 also comprises a latch projection 170 having a second stop 182, second insert 184, and second engagement surface 176, as are generally described in greater detail with respect to first member 20.

Also shown in FIGS. 9a, 9b and 10 is second member 40. In the embodiment of FIGS. 9a, 9b and 10, the second member 40 comprises an image mounting surface 46, optional image contact surfaces 48, pivot 50, a latch recess 88 having a stop 82, and an insert 84 as are generally described with respect to the embodiment of FIG. 1 above. However, in the embodiment of FIGS. 9a, 9b and 10, second member 40 does not have an outer surface 42. Instead, in the embodiment of FIGS. 9a, 9b and 10, second member 40 comprises a second image mounting surface 146, optional second image mounting recess 147, optional image contact surfaces 148, a second pivot 150, a second latch recess 180 having a second mounting surface 190, an optional second stop 182, and a second insert 184 having the features generally described above.

In the embodiment of FIGS. 9a, 9b and 10, third member 120 is fixed to the second pivot 150 of second member 40 in the same manner as is described above with respect to the first member 20. Further the third member 120 is co-operates with second member 40 in the same ways that first member 20 co-operates with second member 40. Thus, the embodiment of FIGS. 9a, 9b and 10 provides an ornamental image holder 10 that can permit a user to easily customize the image holder 10 to support a first image 12 and a second image 14.

Ornamental image holder 10 can be hung from a tree such as a Christmas tree, or can be attached to a key chain or like structure. In this regard, the space S between pivot cylinders 56 and 58 can be defined through mounting member 40 as is shown in FIG. 10 to create a channel 59 through the ornamental image holder 10 to permit a string, wire hangar or other mounting device (not shown) to be affixed to the ornamental image holder 10.

The invention has been described in detail with particular reference to certain preferred embodiments thereof, but it will be understood that variations and modifications can be effected within the spirit and scope of the invention.

PARTS LIST

| | |
|---|---|
| 10 | Ornamental Image Holder |
| 12 | Image |
| 14 | Second image |
| 20 | First member |
| 22 | Outer surface |
| 24 | Window |
| 25 | Passageway |
| 26 | Image retention surface |
| 28 | Image retention recess |
| 30 | Pivot passageway |
| 40 | Second member |
| 42 | Second outer surface |
| 44 | Exterior recess |
| 46 | Image mounting surface |
| 47 | Image mounting recess |
| 48 | Image contact surfaces |
| 50 | Pivot |
| 56 | Partial cylinder |
| 58 | Partial cylinder |
| 59 | Channel |
| 60 | Shoulder region |
| 62 | Shoulder region |
| 64 | Latch |
| 70 | Latch projection |
| 72 | Detent |
| 74 | Groove |
| 76 | Engagement surface |
| 78 | Shoulder |
| 80 | Latch recess |
| 82 | Stop |
| 84 | Insert |
| 86 | Tongue |
| 90 | Mounting surface |
| 92 | Mounting ramp |
| 120 | Third member |
| 146 | Second image mounting surface |
| 147 | Second mounting recess |
| 148 | Optional image contact surfaces |
| 150 | Second pivot |
| 180 | Second latch recess |
| 182 | Second stop |
| 184 | Second insert |
| 190 | Second engagement surface |

What is claimed is:

1. An ornamental holder for holding at least one image, the holder comprising:
a first member having an outer surface and an image retention surface with a window defined between the outer surface and the image retention surface;
a second member having a mounting surface;
wherein the first member is pivotally connected to the second member to permit pivotal motion of the first member and the second member along parallel planes between a first position wherein the mounting surface confronts the image retention surface to hold the image at the window and a second position wherein the mounting surface is separated from the image retention surface to release the image.

2. The ornamental image holder of claim 1, wherein the first member defines a projection that extends between the first member and the second member and wherein the second member defines a recess to receive the projection.

3. The ornamental image holder of claim 2, wherein said recess further comprises an insert and said projection further comprises a detent to receive the insert to hold the second member and first member in the first position.

4. The ornamental image holder of claim 3, wherein said detent and said insert are shaped to hold the mounting surface to the image retention surface when the second member and first member are in the first position.

5. The ornamental image holder of claim 4, wherein the first member defines a pivot passageway and the second member defines a resilient pivot to engage the pivot passageway and to resiliently bias the second member to bias the insert into the detent.

6. The ornamental image holder of claim 4, wherein said detent comprises a groove of a predefined length and said insert defines a tongue of a predefined length to clamp the mounting surface to the image retention surface when the first member and second member are in the first position.

7. The ornamental image holder of claim 3, wherein said recess comprises a shoulder and wherein each projection defines an engagement surface for engaging the shoulder to stop the pivotal movement of each first member at the first position.

8. An ornamental holder for holding at least one image, the holder comprising:
a first member having an outer surface and an image retention surface with a window defined between the outer surface and the image retention surface, the first member further having a pivot passageway defined between the outer surface and the image surface and the ornamental image holder further having an insert;
a second member having a mounting surface, the second member defining a pivot pin and a detent to receive the insert;
wherein the first member is pivotally connected to the second member to permit pivotal motion of the first member and the second member along parallel planes between a first position wherein the mounting surface confronts the image retention surface to hold the image at the window and the detent receives the insert and a second position wherein insert is separated from the detent and the mounting surface is separated from the image retention surface to release the image.

9. The ornamental image holder of claim 8, wherein said pivot pin comprises a resilient pivot pin to engage the pivot passageway and to resiliently bias the insert into the detent.

10. The ornamental image holder of claim 9, wherein said detent comprises a groove of a predefined length and said insert defines a tongue of a predefined length to clamp the mounting surface to the image retention surface when the first member and second member are in the first position.

11. The ornamental image holder of claim 10 wherein said first member comprises a projection containing the detent and the second member comprises a recess defining the insert.

12. The ornamental image holder of claim 11, wherein said recess comprises a shoulder and wherein each projection defines an engagement surface for engaging the shoulder to stop the pivotal movement of each first member at the first position.

13. An ornamental holder for holding at least one image, the holder comprising:
a pair of first members each having an outer surface and an image retention surface with a window defined between the outer surface and the image retention surface; and;
a second member having a pair of mounting surfaces with each mounting surface having a pivot pin;
wherein each one of the first members is pivotally connected to each one of the pivot pins of the second member to permit pivotal motion between each of the first members and the second member along parallel planes between a first position wherein the image retention surface of each first member confronts the mounting surface to hold the image at the window and a second position wherein the mounting surface is separated from the image retention surface to release the image.

14. The ornamental image holder of claim 13, wherein each of the first members defines a projection that extends between the respective first member and the second member and wherein the second member defines a recess to receive the projection in each mounting surface.

15. The ornamental image holder of claim 13, wherein each recess further comprises an insert and each projection further comprises a detent to receive the insert to hold the second member and first member in the first position.

16. The ornamental image holder of claim 15, wherein said detent and said insert are shaped to hold the mounting surfaces to the image retention surfaces when the second member and first members are in the first positions.

17. The ornamental image holder of claim 15 wherein each of the pivot pins resiliently bia the insert into the detent when the ornamental image holder is in the closed position.

18. The ornamental image holder of claim 15, wherein said detent comprises a groove of a predefined length and said insert defines a tongue of a predefined length to clamp the mounting surface to the image retention surface when the first member and second member are in the first position.

19. The ornamental image holder of claim 14, wherein each recess comprises a shoulder and wherein each projection defines an engagement surface for engaging a shoulder to stop the pivotal movement of each first member at the first position.

20. An ornamental holder for holding at least one image, the holder comprising:
a pair of first members each having an outer surface and an image retention surface with a window defined between the outer surface and the image retention surface and with a projection extending from the image retention surface; and;
a second member having a pair of mounting surfaces with each mounting surface having a pivot pin and an insert positioned away from the pivot pin and shaped for engagement with the detent in image retention surface of one of said first members;
wherein each one of the first members is pivotally connected to each one of the pivot pins of the second member to permit pivotal motion between each of the first members and the second member along parallel planes between a first position wherein the image retention surface of each first member confronts the mounting surface to hold the image at the window and a second position wherein the mounting surface is separated from the image retention surface to release the image, wherein the projection of the first member engages the recess of the second member when the ornamental image is in the closed position.

21. The ornamental image holder of claim 20, wherein said detent comprises a groove of a predefined length and said insert defines a tongue of a predefined length to clamp the mounting surface to the image retention surface when the first member and second member are in the first position.

22. The ornamental image holder of claim 20 wherein said first member comprises a projection containing the detent and the second member comprises a recess defining the insert.

23. The ornamental image holder of claim 22, wherein said recess comprises a shoulder and wherein each projection defines an engagement surface for engaging the shoulder to stop the pivotal movement of each first member at the first position.
